(19) United States
(12) Patent Application Publication
(10) Pub. No.: US 2012/0090508 A1
(43) Pub. Date: Apr. 19, 2012

(54) METHOD FOR PRODUCING WET GYPSUM ACCELERATOR

(75) Inventors: Brent GROZA, Grayslake, IL (US); Qiang YU, Grayslake, IL (US)

(73) Assignee: UNITED STATES GYPSUM COMPANY, Chicago (US)

(21) Appl. No.: 12/907,767

(22) Filed: Oct. 19, 2010

(51) Int. Cl. C04B 11/00; C04B 16/00

(52) U.S. Cl. 106/778; 106/772

(57) ABSTRACT

The present invention relates to an improved method of preparing wet gypsum accelerator comprising the use of dry gypsum having a median particle size of about 20 microns or less. In addition, the present invention relates to a method of hydrating calcined gypsum to form an interlocking matrix of set gypsum comprising the use of the dry gypsum. Furthermore, the invention relates to wet gypsum accelerator and set gypsum-containing compositions and products prepared by the foregoing process and method.

### BACKGROUND OF THE INVENTION

Set gypsum (calcium sulfate dihydrate) is a well-known material that is included commonly in many types of products, such as gypsum board employed in typical drywall construction of interior walls and ceilings of buildings. In addition, set gypsum is the major component of gypsum/cellulose fiber composite boards and products, and also is included in products that fill and smooth the joints between edges of gypsum boards. Typically, such gypsum-containing products are prepared by forming a mixture of calcined gypsum, that is, calcium sulfate hemihydrate and/or calcium sulfate anhydrite, and water, as well as other components, as desired. The mixture typically is cast into a pre-determined shape or onto the surface of a substrate. The calcined gypsum reacts with water to form a matrix of crystalline hydrated gypsum or calcium sulfate dihydrate. The desired hydration of the calcined gypsum is what enables the formation of an interlocking matrix of set gypsum crystals, thereby imparting strength to the gypsum structure in the gypsum-containing product. Mild heating can be used to drive off unreacted water to yield a dry product.

Accelerator materials are commonly used in the production of gypsum products to enhance the efficiency of hydration and to control set time. Accelerators are described, for example, in U.S. Pat. Nos. 3,573,947, 3,947,285, and 4,054,461. Wet gypsum accelerator (WGA), which comprises particles of calcium sulfate dihydrate, water, and at least one additive, is described in U.S. Pat. No. 6,409,825 and in commonly assigned U.S. Patent Application Publication Nos. 2006/0243171 and 2006/0244183, each of which is incorporated by reference herein.

WGA is typically prepared by wet grinding calcium sulfate dihydrate, as combined with water or after it is formed in water from calcined gypsum, usually in the presence of an additive. By way of example, the mixture comprising calcium sulfate dihydrate, water, and additive can be milled under conditions sufficient to provide a slurry in which the calcium sulfate dihydrate particles have a median particle size of less than about 5 microns (μm). Generally, the smaller the median particle size of the resulting ground product, the better the acceleration efficiency for making set gypsum-containing compositions and products.

Although WGA as known heretofore is suitable for its intended purpose, the wet grinding process used to prepare WGA can result in rapid wear on the milling equipment. Such rapid wear results in increased maintenance on the milling equipment, which limits productivity and efficiency while increasing production costs. Accordingly, there remains a need for an improved method of producing WGA that provides greater efficiency and/or reduced maintenance costs. The invention provides such a method. These and other advantages of the invention as well as additional inventive features will be apparent from the description of the invention provided herein.

### BRIEF SUMMARY OF THE INVENTION

The invention provides an improved method of preparing WGA comprising the use of dry gypsum having a reduced median particle size. Applicants have surprisingly discovered that using dry gypsum having a reduced median particle size to prepare WGA results in one or more advantages, including, for example, reduced wear on milling equipment, less equipment down time, lower maintenance costs, increased productivity, and shorter hydration times.

In one embodiment, the invention provides a process for preparing a wet gypsum accelerator comprising (i) combining dry gypsum having a median particle size of less than about 20 μm and water to form a wet gypsum mixture, and (ii) grinding the wet gypsum mixture for a period of time sufficient to reduce the median particle size of the gypsum in the wet gypsum mixture to form the wet gypsum accelerator.

In another embodiment, the invention provides a method of hydrating calcined gypsum to form an interlocking matrix of set gypsum comprising forming a mixture of calcined gypsum, water, and WGA, wherein the WGA is prepared using dry gypsum having a median particle size of about 20 microns or less, and whereby an interlocking matrix of set gypsum is formed.

In yet another embodiment, the invention provides a set gypsum-containing composition comprising an interlocking matrix of set gypsum formed from at least calcined gypsum, water, and WGA, wherein the WGA is prepared using dry gypsum having a median particle size of about 20 μm or less, and wherein the WGA is present in an amount effective to accelerate and/or control the hydration of calcined gypsum to form set gypsum. The invention further provides WGA and set gypsum-containing products prepared by the foregoing process and method.

### DETAILED DESCRIPTION OF THE INVENTION

The invention provides an improved method of preparing WGA and set gypsum-containing products therefrom. Generally, WGA is prepared by grinding calcium sulfate dihydrate in the presence of water until the calcium sulfate dihydrate particles have a desired median particle size. Applicants have surprisingly discovered that the overall grinding time required to prepare WGA can be reduced by using dry gypsum feed stock having a reduced median particle size compared to the initial median particle size of typical gypsum feed stock as received from the source.

Thus, in accordance with the invention, the dry gypsum obtained with or without grinding (e.g., a natural source or synthetically prepared) used to prepare WGA has a median particle size of about 20 microns or less (e.g., about 19 microns or less). Typically, the dry gypsum has median particle size of about 18 microns or less (e.g., about 17 microns, or 16 microns or less) or about 15 microns or less (e.g., about 14 microns, about 13 microns, or about 12 microns or less). In some embodiments, the dry gypsum has a median particle size of about 5 microns or less. Also typically the dry gypsum has a median particle size of about 0.5 micron or more. In accordance with the invention, any combination of the aforesaid ranges is contemplated. For example, in some embodiments the dry gypsum has a median particle size of from about 0.5 to about 18 microns or from about 1 to about 14 microns. Preferably, the dry gypsum has a median particle size of from about 2 microns (e.g., about 1, about 1.5, about 2, or about 2.5 microns) to about 12 microns. As used herein, “about” refers to ±0.5 μm. Methods of measuring the median particle size are well-established in the gypsum art. By way of example, median particle size can be determined by laser scattering analysis and/or other appropriate techniques. Suitable laser scattering instruments are available from, for example, Horiba, Microtrack, and Malvern Instruments.

The dry gypsum used in accordance with the invention can have any suitable particle size distribution. The particle size distribution will depend, at least in part, on the nature of the milling equipment used to grind dry gypsum (if applicable), for example, the size of the ball mill and the grinding medium used to prepare the ground gypsum. As is known to the skilled artisan, particle size distribution is often reported using d(0.1), d(0.5), and d(0.9) values, which describe the shape of the particle size distribution. Typically, the dry gypsum has a d(0.9) value of about 300 microns or less, a d(0.5) value of about 20 microns or less, and a d(0.1) value of about 10 microns or less. Preferably, the dry gypsum has a d(0.9) value of about 250 microns or less, about 200 microns or less, or about 150 microns or less; a d(0.5) value of about 15 microns or less, about 10 microns or less, about 8 microns or less, or about 5 microns or less; and a d(0.1) value of about 8 microns or less, about 5 microns or less, about 3 microns or less, about 2 microns or less, or about 1 micron or less.

The dry gypsum used in accordance with the invention can have any suitable surface area. Typically, the dry gypsum has a surface area of about 0.15 m²/g or more, as determined by laser scattering analysis. Preferably, the dry gypsum has a surface area of about 0.18 m²/g or more or about 0.2 m²/g or more. Generally, the dry gypsum has a surface area of about 5 m²/g or less, about 3 m²/g or less, or about 2 m²/g or less. In a preferred embodiment, the dry gypsum has a surface area of from about 0.15 m²/g to about 3 m²/g, or from about 0.2 m²/g to about 2 m²/g.

The dry gypsum used in accordance with the invention is flowable and substantially free from excess moisture. Typically, the dry gypsum of the present invention has a moisture content of about 5% or less, or about 3% or less, or about 1% or less, or about 0.5% or less. More preferably, the dry gypsum has a moisture content of about 0.3% or less, about 0.2% or less, about 0.1% or less, or about 0%.

The dry gypsum can be obtained from any suitable source. For example, the dry gypsum can be obtained by mining or can be prepared by a synthetic process. In some embodiments, the dry gypsum comprises a combination of mined gypsum and synthetic gypsum. Impurities in gypsum used to prepare WGA, for example clay, anhydrite, or limestone impurities in natural gypsum or fly ash impurities in synthetic gypsum, can limit the efficiency of WGA production. By way of example, limestone rock present in naturally mined gypsum such as Southard landplaster can lead to premature wear of milling equipment resulting in increased down time and maintenance costs. It has been surprisingly discovered that preparing WGA from dry gypsum having a median particle size of about 20 microns or less in accordance with the invention results in a higher acceptable levels of impurities, thereby greatly increasing productivity. Accordingly in some embodiments, the dry gypsum of the present invention can contain from about 0 wt. % to about 25 wt. % of impurities by volume. Preferably, the dry gypsum of the invention comprises from about 0 wt. % to about 20 wt. % of impurity, or 0 wt. % to about 15 wt. % of impurity, or 0 wt. % to about 10 wt. % of impurity, or about 0 wt. % to about 5 wt. % impurity by volume.

Dry gypsum having the desired median particle size can be obtained by any suitable method and under any suitable conditions. Typically, the dry gypsum of the invention is obtained by dry grinding as received gypsum material until the desired median particle size is achieved. In the context of this invention, as received gypsum material refers to gypsum material in the form received from the source without further processing. However, in some embodiments, dry gypsum having the desired median particle size can be obtained without grinding; for instance, the dry gypsum may be mined gypsum having a median particle size of less than about 20 microns as received (e.g., about 19 microns, about 18 microns, about 17 microns, about 16 microns, about 15 microns, about 14 microns, about 13 microns, or about 12 microns or less). Also typically the dry gypsum without grinding has a median particle size of about 0.5 micron or more. In accordance with the invention, any combination of the aforesaid ranges is contemplated. Preferably, the dry gypsum without grinding has a median particle size of from about 2 microns (e.g., about 1, about 1.5, about 2, or about 2.5 microns) to about 12 microns. For example, in some embodiments the dry gypsum without grinding has a median particle size of from about 0.5 to about 18 microns or from about 1 to about 14 microns. Similarly, the dry gypsum can be prepared synthetically having a median particle size of less than about 20 microns (e.g., about 19 microns, about 18 microns, about 17 microns, about 16 microns, about 15 microns, about 14 microns, about 13 microns, or about 12 microns or less). Also typically the dry gypsum prepared synthetically has a median particle size of about 0.5 micron or more. In accordance with the invention, any combination of the aforesaid ranges is contemplated. Preferably, the dry gypsum prepared synthetically has a median particle size of from about 2 microns (e.g., about 1, about 1.5, about 2, or about 2.5 microns) to about 12 microns. For example, in some embodiments the dry gypsum prepared synthetically has a median particle size of from about 0.5 to about 18 microns or from about 1 to about 14 microns. Such gypsum can be used as received without further grinding to prepare a WGA of the inventive method.

In some embodiments, the process for preparing WGA comprises dry grinding the dry gypsum to obtain dry gypsum with a median particle size of about 20 microns or less, as described herein. When the dry gypsum is prepared by dry grinding, the as received gypsum material can have any suitable initial median particle size. The initial median particle size of the as received gypsum material will depend, at least in part, on the source of the material and/or the manner in which it was prepared. Typically the as received gypsum material has an initial median particle size of about 20 microns or greater. In some embodiments the as-received gypsum material has an initial median particle size of about 50 microns or greater. In other embodiments, the as-received gypsum material has an initial median particle size of about 20 to about 30 microns. In yet other embodiments, the as-received gypsum material has an initial median particle size of about 40 microns to about 100 microns.

Grinding equipment suitable for use in dry milling in accordance with the present invention is well-known to the skilled artisan and can include any suitable dry milling assembly, for example, a ball mill such as an Ersham mill. Typically, the mill assembly comprises a cylindrical chamber that rotates around a horizontal axis, partially filled with the material to be ground and the grinding media. Typically, the volume of ball grinding media in the cylindrical chamber is from about 40% to about 60%. The diameter of the cylindrical chamber is typically from about 2 feet to about 4 feet. Preferably, the milling assembly is jacketed such that it can be water cooled to maintain a constant grinding temperature throughout the mill. Desirably, the temperature in the mill assembly does not exceed about 74° C. The mill assembly is often vented to remove free moisture from the mill.

Often, the milling assembly operates continuously, with material being fed into the mill at one end and being discharged at the other end. The path of the mill assembly can have any suitable length and typically ranges from about 8 feet (2.4 m) to about 30 feet (9.1 m). The diameter of the mill also varies depending on the size of the mill assembly and typically ranges from 18 inches (45.7 cm) to 60 inches (152.4 cm). The feed rate at which material is introduced into the mill can vary as appropriate and depends, at least in part, on the milling assembly, the size of the mill, the grinding media, the speed of the manufacturing line, and the desired result. The feed rate can range from, for example, about 100 lbs/h (45.5 kg/h) to about 3000 lbs/h (113.6 kg/h) depending on these factors as will be appreciated by the ordinary artisan. In some embodiments, the feed rate is about 180 lbs/h (81.8 kg/h).

The ball grinding media can comprise any suitable material, for example, the grinding media can comprise one or more metals, one or more ceramics, or combinations thereof. Typically the balls comprise a metal selected from the group consisting of stainless steel, carbon steel, chrome alloy steel, and the like. Suitable ceramic materials include zirconia, alumina, ceria, silica, glasses, and the like. Preferably the balls comprise or consist essentially of stainless steel.

In addition, the grinding media used in connection with the mill assembly can have any suitable size and density. The size and density of the grinding media will determine, at least in part, the median particle size of the dry gypsum. Desirably the grinding media have an average diameter of from about 10 mm to about 50 mm. Preferably, the grinding media have an average diameter of from about 20 mm to about 40 mm. More preferably, the ball grinding media are 1″ (25.4 mm) or 1.5″ (38.1 mm) diameter balls. Desirably the grinding media have a density of about 2.5 g/cm³ or greater. Preferably, the grinding media have a density of about 4 g/cm³ or greater. More preferably, the grinding media have a density of about 6 g/cm³ or greater.

In some embodiments, high humidity levels can limit the efficiency of the dry gypsum grinding process such that it is desirable to maintain a low humidity during the grinding step. In these embodiments, the humidity of the dry grinding chamber typically is about 50% or less, or about 40% or less, about 30% or less, or about 20% or less.

WGA prepared using dry gypsum in accordance with the invention can be prepared in a batch process or in a continuous process. When WGA is prepared in a batch process, the dry gypsum having a median particle size of about 20 microns or less, water, and at least one additive are mixed in a single step. When WGA is prepared in a continuous process, the water, dry gypsum, and additive(s) are continuously added to the mixture while a portion of the mixture continuously removed for use as WGA. In one aspect, WGA is prepared by a process comprising (i) combining dry gypsum having a median particle size of less than about 20 microns and water to form a wet gypsum mixture and (ii) grinding the wet gypsum mixture for a period of time sufficient to reduce the median particle size of the gypsum in the wet gypsum mixture to form the wet gypsum accelerator. The wet gypsum mixture prepared by grinding in accordance with step (ii) can be used as WGA without further modification. Steps (i) and (ii) can be carried out sequentially or simultaneously.

WGA prepared in accordance with the invention preferably comprises one or more additives particularly for enhancing surface chemistry to facilitate formation of nucleation sites, desirable for acceleration, including, for example, phosphonic or phosphate-containing ingredients such as those described in U.S. Pat. No. 6,409,825 and U.S. Patent Application Publication Nos. 2006/0243171 and 2006/0244183. Suitable additives include compounds selected from the group consisting of an organic phosphonic compound, a phosphate-containing compound, and mixtures thereof. Preferably, WGA prepared in accordance with the invention comprises at least one additive selected from the group consisting of an organic phosphonic compound, a phosphate-containing compound, and mixtures thereof.

While not wishing to be bound by any particular theory, it is believed that, upon grinding, the desired additives according to the invention become affixed to the freshly generated outer surface of the calcium sulfate dihydrate, providing at least a partial coating on the calcium sulfate dihydrate. It also is believed that the additives strongly and rapidly adsorb on active sites of the calcium sulfate dihydrate surface of the accelerator, where unwanted recrystallization can otherwise occur. As a result, it also is believed that by adsorbing on such active sites, the additives protect the size and shape of the active sites to prevent gypsum recrystallization of the ground gypsum upon exposure to heat and/or moisture and to protect the active sites of the ground gypsum during the wet grinding process. Thus, the irregular shape of the freshly ground gypsum particles is preserved, thereby maintaining the number of available nucleation sites for crystallization.

Additives, when present, can be added at any suitable time during the inventive process. In keeping with the invention, the additive(s) can be added prior to or during grinding the wet gypsum mixture. Alternatively, or in addition to, the additive(s) can be added to the dry gypsum prior to forming the wet gypsum mixture. For example, if the additive(s) is in a liquid form (e.g., an aqueous phosphonate solution) it can be combined with the wet gypsum mixture, and if the additive is in a dry form (e.g., phosphate) it can be combined with the dry gypsum prior to forming the wet gypsum mixture. In addition, more than one of each type of additive can be used in the practice of the invention. In an embodiment, the inventive process further comprises combining at least one additive and the wet gypsum mixture prior to or during grinding the wet gypsum mixture. In another embodiment, the process comprises further comprises combining at least one additive with the dry gypsum prior to forming the wet gypsum mixture.

The organic phosphonic compounds suitable for use in the WGA of the invention at least one RPO₃M₂ functional group, where M is a cation, phosphorus, or hydrogen, and R is an organic group. Examples include organic phosphonates and phosphonic acids. Organic polyphosphonic compounds are preferred although organic monophosphonic compounds can be utilized as well according to the invention. The preferred organic polyphosphonic compounds include at least two phosphonate salt or ion groups, at least two phosphonic acid groups, or at least one phosphonate salt or ion group and at least one phosphonic acid group. A monophosphonic compound according to the invention includes one phosphonate salt or ion group or at least one phosphonic acid group.

The organic group of the organic phosphonic compounds is bonded directly to the phosphorus atom. The organic phosphonic compounds suitable for use in the invention include, but are not limited to, water soluble compounds characterized by the following structures:

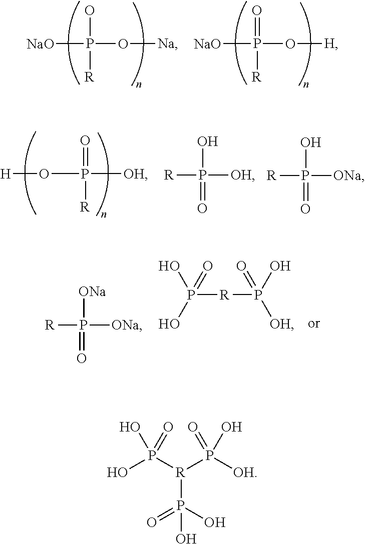

In these structures, R refers to an organic moiety containing at least one carbon atom bonded directly to a phosphorus atom P, and n is a number of from about 1 to about 20, preferably a number of from about 2 to about 10 (e.g., 4, 6, or 8).

Organic phosphonic compounds include, for example, aminotri(methylenephosphonic acid), 1-hydroxyethylidene-1,1-diphosphonic acid, diethylenetriamine penta(methylenephosphonic acid), hexamethylenediamine tetra(methylenephosphonic acid), as well as any suitable salt thereof, such as, for example, potassium salt, sodium salt, ammonium salt, calcium salt, or magnesium salt of any of the foregoing acids, and the like, or combinations of the foregoing salts and/or acids. In some embodiments, DEQUEST™ phosphonates commercially available from Solutia, Inc., St. Louis, Mo., are utilized in the invention. Examples of DEQUEST™ phosphonates include DEQUEST™ 2000, DEQUEST™ 2006, DEQUEST™ 2016, DEQUEST™ 2054, DEQUEST™ 2060S, DEQUEST™ 2066A, and the like. Other examples of suitable organic phosphonic compounds are found, for example, in U.S. Pat. No. 5,788,857, the disclosure of which is incorporated herein by reference.

Any suitable phosphate-containing compound can be utilized. By way of example, the phosphate-containing compound can be an orthophosphate or a polyphosphate. The phosphate-containing compound can be in the form of an ion, salt, or acid.

Suitable examples of phosphates according to the invention will be apparent to those skilled in the art. For example, any suitable orthophosphate-containing compound can be utilized in the practice of the invention, including, but not limited to, monobasic phosphate salts, such as monoammonium phosphate, monosodium phosphate, monopotassium phosphate, or combinations thereof. A preferred monobasic phosphate salt is monosodium phosphate. Polybasic orthophosphates also can be utilized in accordance with the invention.

Similarly, any suitable polyphosphate salt can be used in accordance with the present invention. The polyphosphate can be cyclic or acyclic. Examples of cyclic polyphosphates include trimetaphosphate salts, including double salts, that is, trimetaphosphate salts having two cations. The trimetaphosphate salt can be selected, for example, from sodium trimetaphosphate, potassium trimetaphosphate, calcium trimetaphosphate, sodium calcium trimetaphosphate, lithium trimetaphosphate, ammonium trimetaphosphate, aluminum trimetaphosphate, and the like, or combinations thereof. Sodium trimetaphosphate is a preferred trimetaphosphate salt. Also, any suitable acyclic polyphosphate salt can be utilized in accordance with the present invention. Preferably, the acyclic polyphosphate salt has at least two phosphate units. By way of example, suitable acyclic polyphosphate salts in accordance with the present invention include, but are not limited to, pyrophosphates, tripolyphosphates, sodium hexametaphosphate having from about 6 to about 27 repeating phosphate units, potassium hexametaphosphate having from about 6 to about 27 repeating phosphate units, ammonium hexametaphosphate having from about 6 to about 27 repeating phosphate units, and combinations thereof. A preferred acyclic polyphosphate salt pursuant to the present invention is commercially available as CALGON™ from Solutia, Inc., St. Louis, Mo., which is a sodium hexametaphosphate having from about 6 to about 27 repeating phosphate units. In addition, the phosphate-containing compound can be in the acid form of any of the foregoing salts. The acid can be, for example, a phosphoric acid or polyphosphoric acid.

Preferably, the phosphate-containing compound is selected from the group consisting of tetrapotassium pyrophosphate, sodium acid pyrophosphate, sodium tripolyphosphate, tetrasodium pyrophosphate, sodium potassium tripolyphosphate, sodium hexametaphosphate salt having from 6 to about 27 phosphate units, ammonium polyphosphate, sodium trimetaphosphate, and combinations thereof.

Once the dry gypsum having a median particle size of about 20 microns or less is combined with water to form the wet gypsum mixture, the median particle size of the gypsum in the wet gypsum mixture can be further reduced using any suitable grinding method. Typically, the median particle size of the gypsum in the wet gypsum mixture is further reduced by wet grinding. Grinding equipment suitable for use in accordance with step (ii) is well-known to the skilled artisan and can include any suitable milling assembly, for example, a bead mill. Typically, the mill assembly comprises a grinding chamber containing a mill shaft fitted with discs and spacers and a plurality of grinding medium. As understood by one of ordinary skill in the art, grinding the mixture reduces the size (e.g., median size) of particles present in the liquid containing mixture.

It is appreciated that the mill assembly can comprise more than one mill. Accordingly, the wet milling can be performed in a single mill or using multiple mills arranged in series. The use of multiple mills allows for a shorter throughput time by performing a portion of the total grinding time in each mill. The multiple mill assembly also allows for the use of different grinding media in each mill to optimize the grinding efficiency. Suitable multiple mill assemblies are commercially available. An illustrative multiple mill is the Duplex Mill CMC-200-001 available from CMC. The number of mills in a multiple mill assembly can be any suitable number, as appropriate (e.g., from 2 to 5). In a preferred embodiment, the number of mills is 2.

The skilled artisan will appreciate that when using a multiple mill assembly, the additive(s) can be added at any suitable time during grinding. By way of example, when the wet milling assembly comprises 2 mills, the WGA of the invention can be added to the first mill in the line and/or added to the second mill, as appropriate.

The discs and spacers can comprise any suitable material, for example stainless steel, PREMALLOY™ alloy, nylon, ceramics, and polyurethane. Preferably, at least one of the discs and spacers comprises stainless steel or PREMALLOY™ alloy. In addition, the discs selected for use in the grinding chamber can have any suitable shape. Typically, the discs are standard flat discs or pinned discs, in particular pinned discs that are designed to improve axial flow of media through the mill. The mill shaft and corresponding grinding chamber can be oriented horizontally or vertically. In preferred embodiments, the mill shaft is oriented horizontally. Typically, the grinding chamber is jacketed such that it can be water cooled. Preferably, the grinding chamber is water cooled to maintain a constant grinding temperature. Examples of particular ball mills suitable for the present invention include, for example, mills from Premier Mills, CMC, and Draiswerke.

The mill assembly can comprise any suitable grinding media, for example, beads, shots, ballcones, cylinders, and combinations thereof. Typically the grinding media are beads. The grinding media can comprise any suitable material, for example, the grinding media can comprise one or more metals, one or more ceramics, or combinations thereof. Suitable metals include stainless steel, carbon steel, chrome alloy steel, and the like. Suitable ceramic materials include zirconia, alumina, ceria, silica, glasses, and the like. Sulfate groups present in the calcium sulfate dihydrate produce a corrosive environment within the mill. Accordingly, it is preferable to use grinding media that are resistant to corrosion. Corrosion-resistant grinding media include stainless steel grinding media or steel grinding media that are coated with corrosion-resistant materials and ceramic grinding media. Suitable wet grinding media include those available from Quackenbush Company, Inc, including grinding media comprising 99% silica (Quacksand); soda-lime silica glass (Q-Bead and Q-Ball); soda-lime silica glass plus calcium oxide and calcium oxide (Ceramedia 700); 58% zirconium dioxide and 37% silicon dioxide (Zirconia QBZ-58™); 95% zirconium dioxide and 4% magnesium oxide and calcium oxide (Zirconia QBZ-95™); and medium carbon through hardened steel (Quackshot). In a particularly preferred embodiment, the grinding media comprise ceria-stabilized zirconia comprising 20% ceria and 80% zirconia, for example ZIRCONOX™ beads commercially available from Jyoti Ceramic Inds., Nashik, India.

The grinding media used in-connection with the mill assembly can have any suitable size and density. The size and density of the grinding media will determine, at least in part, the median particle size of the dry gypsum. Typically, it is desirable to use grinding media having an average diameter of from about 1 mm to about 4 mm. Preferably, the grinding media have an average diameter of from about 1.7 mm to about 2.4 mm. Desirably the grinding media have a density of about 2.5 g/cm³ or greater. Preferably, the grinding media have a density of about 4 g/cm³ or greater. More preferably, the grinding media have a density of about 6 g/cm³ or greater. In a particularly preferred embodiment, the grinding media are ZIRCONOX™ ceramic beads having an average diameter of from about 1.7 mm to about 2.4 mm and a density of about 6.1 g/cm³ or greater.

The mill assembly used for wet grinding can contain any suitable volume of grinding media in the grinding chamber. Desirably the grinding chamber comprises about 70 volume % or greater grinding media, based on the total volume of the grinding chamber. Preferably the grinding chamber comprises about 70 volume % to about 90 volume % grinding media. More preferably about 75 volume % to about 85 volume % of the grinding medium is present in the grinding chamber.

The target median particle size of gypsum in the wet gypsum mixture after wet grinding is dependent on many factors, such as the desired application for the WGA. Typically, the wet gypsum mixture is ground until the median particle size of the gypsum is from about 0.5 microns to about 2 microns. Preferably, the wet gypsum mixture is ground until the median particle size of the gypsum is from about 1 micron to about 1.7 microns, preferably from about 1 micron to about 1.5 microns. In a particularly preferred embodiment, the wet gypsum mixture is ground until the median particle size of the gypsum is about 1.5 microns after grinding.

For a batch process, the wet gypsum mixture of the inventive process can be ground for any suitable period of time. This grinding time is dependent on many factors, for example, the grinding equipment, the desired particle size of the WGA, and the amount of material being prepared. Typically, the wet gypsum mixture is ground for about 10 minutes to about 50 minutes, preferably for about 20 to about 40 minutes, more preferably from about 25 to about 35 minutes.

The wet gypsum mixture or WGA of the inventive process can have any suitable viscosity. In keeping with an aspect of the invention, the viscosity of the wet gypsum mixture is measured using methods known to one of ordinary skill in the art. As one of ordinary skill in the art will appreciate, viscosity can be measured in different ways. As used herein, viscosity measurements desirably are measured using a Brookfield viscometer (e.g., Brookfield RVT) with a suitable spindle (e.g., #4 spindle at 40 rpm). The viscometers are operated at room temperature (e.g., 20-25° C.) and ambient pressure according to the manufacturer's operating instructions. Desirably, the wet gypsum mixture is ground under conditions sufficient to provide a slurry comprising about 40-45% solids content and having a viscosity in the range of about 1000 cP or greater at a wet gypsum mixture temperature range from room temperature to about 150° F. (65.6° C.), since the temperature of the wet gypsum mixture increases during grinding. Typically, the WGA has a viscosity in the range of from about 1000 cP to about 5000 cP. Preferably, the WGA has a viscosity in the range of from about 2000 cP to about 4000 cP. More preferably, the WGA has a viscosity in the range of from about 2500 cP to about 3500 cP. In some embodiments, the viscosity range is about 2800 cP to about 3200 cP. The above viscosity ranges are ranges measured in the absence of dispersants or other chemical additives that would have a significant effect on viscosity or the measurement thereof.

In the manufacture of product (e.g., board such as wallboard), WGA prepared in accordance with the invention desirably is added to an aqueous calcined gypsum mixture in an amount effective to accelerate and/or control the rate of conversion of the calcined gypsum mixture to set gypsum. The WGA can be added to the aqueous calcined gypsum mixture in any suitable manner. For example, once WGA of the invention is prepared, using either a batch process or a continuous process, it can be fed to a holding tank or a “surge” tank, from which the WGA can be fed at a continuous rate to the board manufacturing production line where the WGA is desirably added to the calcined gypsum mixture. The WGA can be added to the calcined gypsum mixture in a mixer and/or via post-mixing as described in, for example, U.S. Patent Application Publication Nos. 2006/0243171 and 2006/0244183.

Typically, the rate of hydration is evaluated on the basis of the “Time to 50% Hydration.” In general, Time to 50% hydration can be shortened by using more accelerators. Gypsum accelerator provides nucleation sites so that more dihydrate crystals form and a larger number of thinner gypsum crystals are provided. Other accelerators, such as potash and aluminum sulfate, make existing gypsum crystals grow faster, resulting in fewer, thicker crystals. Typically, a large number of thinner gypsum crystals make a stronger better matrix compared to fewer thicker gypsum crystals.

Because the hydration of calcined gypsum to set gypsum is an exothermic process, the Time to 50% Hydration can be calculated by determining the midpoint of the temperature increase caused by the hydration and then measuring the amount of time required to generate the temperature rise, as is known to those skilled in the art. The Time to 50% Hydration can be affected by a number of different factors such as the amount of accelerator used, the efficiency of the accelerator, the amounts of calcium sulfate hemihydrate and water used, and the initial slurry temperature. When measuring hydration, a control can be run with fixed variables except for that variable being tested, such as amount or type of WGA. This procedure allows for the comparison of various types of accelerators in general as well as specific types of WGA. Preferably, the WGA according to the invention results in Time to 50% Hydration of the calcined gypsum of about 8 minutes or less, more preferably 6 minutes or less. Even more preferably, use of WGA prepared in accordance with the invention results in the Time to 50% Hydration of the calcined gypsum of about 5 minutes or less to about 4 minutes or less. Most preferably, use of WGA prepared in accordance with the invention results in the Time to 50% Hydration of the calcined gypsum of about 3 minutes or less to about 2 minutes or less.

The amount of WGA added to an aqueous calcined gypsum mixture will depend on the components of the aqueous calcined gypsum mixture, such as the inclusion of set retarders, dispersants, foam, starch, paper fiber, and the like. By way of example, wet gypsum accelerator of the inventive process can be provided in an amount of from about 0.05% to about 3% by weight of the calcined gypsum, more preferably, in an amount of from about 0.5% to about 2% by weight of the calcined gypsum.

The gypsum material used to prepare the dry gypsum included in the wet gypsum accelerator of the invention typically comprises predominantly calcium sulfate dihydrate. In some embodiments, the gypsum material further comprises small amounts of calcium sulfate alpha hemihydrate, calcium sulfate beta hemihydrate, water-soluble calcium sulfate anhydrite, or mixtures of these various forms of calcium sulfate hemihydrates and anhydrites. The gypsum material additionally can comprise fibrous or non-fibrous gypsum. Furthermore, WGA prepared in accordance with the invention can be used to accelerate hydration of calcined gypsum of any of these forms of calcium sulfate hemihydrates and anhydrites as well as mixtures of the various forms of calcium sulfate hemihydrates and anhydrites such as fibrous and non-fibrous forms of calcined gypsum.

Accordingly, in another embodiment, the present invention provides a method of hydrating calcined gypsum to form an interlocking matrix of set gypsum comprising forming a mixture of calcined gypsum, water, and wet gypsum accelerator, wherein the wet gypsum accelerator is prepared using dry gypsum having a reduced particle size as described above, whereby an interlocking matrix of set gypsum is formed. Typically, the WGA is present in an amount effective to accelerate and/or control the hydration of calcined gypsum, wherein the WGA is added to the aqueous calcined gypsum in a suitable manner as known to one of ordinary skill in the art to affect the hydration of at least some calcined gypsum to form an interlocking matrix of set gypsum. Preferably, all of the calcined gypsum is hydrated to form an interlocking matrix of set gypsum.

The present invention further provides set gypsum-containing products prepared in accordance with the inventive method and process described above. Such set gypsum-containing products include, for example, conventional gypsum board or gypsum-cellulosic fiber board such as FIBEROCK™ composite panels, commercially available from USG Corporation, as well as ceiling materials, flooring materials, joint compounds, plasters, specialty products, and the like.

The following examples further illustrate the invention but, of course, should not be construed as in any way limiting its scope.

### EXAMPLE 1

This example illustrates a process for producing dry gypsum having a median particle size of less than 20 microns in accordance with the invention.

Calcium sulfate dihydrate (landplaster) was obtained from USG's Southard plant. A portion of this material was ground using an Ersham dry ball mill comprising 40-45 volume % (250 lbs; 113.6 kg) of 1″ stainless steel balls at a feed rate of 180 lbs/hr (81.8 kg/h). The particle size distribution of the landplaster before and after grinding was measured using a particle size analyzer from Malvern Instruments including a Scirocco 2000 dry powder feeder.

The particle size distributions for the “as received” gypsum (1A) and ground materials (1B) are provided in Table 1.

TABLE 1

| | | Cumulative | | |
|---|---|---|---|---|
| Size | Volume % | Volume % | Volume % | Cumulative |
| (μm) | 1A | 1A | 1B | Volume % 1B |
| 0.275 | 0 | 0 | 0.011305 | 0.011305 |
| 0.316 | 0 | 0 | 0.104569 | 0.115874 |
| 0.363 | 0 | 0 | 0.145294 | 0.261168 |
| 0.417 | 0 | 0 | 0.189801 | 0.450969 |
| 0.479 | 0 | 0 | 0.236124 | 0.687093 |
| 0.55 | 0 | 0 | 0.286905 | 0.973998 |
| 0.631 | 0 | 0 | 0.342298 | 1.316296 |
| 0.724 | 0.061787 | 0.061787 | 0.407309 | 1.723605 |
| 0.832 | 0.15896 | 0.220747 | 0.484051 | 2.207656 |
| 0.955 | 0.263403 | 0.48415 | 0.579564 | 2.78722 |
| 1.096 | 0.332117 | 0.816267 | 0.697516 | 3.484736 |
| 1.259 | 0.39953 | 1.215797 | 0.845876 | 4.330612 |
| 1.445 | 0.454374 | 1.670171 | 1.027635 | 5.358247 |
| 1.66 | 0.502406 | 2.172577 | 1.249095 | 6.607342 |
| 1.905 | 0.545304 | 2.717881 | 1.511402 | 8.118744 |
| 2.188 | 0.587779 | 3.30566 | 1.816383 | 9.935127 |
| 2.512 | 0.634723 | 3.940383 | 2.158706 | 12.093833 |
| 2.884 | 0.690592 | 4.630975 | 2.528342 | 14.622175 |
| 3.311 | 0.759639 | 5.390614 | 2.911659 | 17.533834 |
| 3.802 | 0.844167 | 6.234781 | 3.283581 | 20.817415 |
| 4.365 | 0.946914 | 7.181695 | 3.621701 | 24.439116 |
| 5.012 | 1.06719 | 8.248885 | 3.89428 | 28.333396 |
| 5.754 | 1.206987 | 9.455872 | 4.080064 | 32.41346 |
| 6.607 | 1.362998 | 10.81887 | 4.156524 | 36.569984 |
| 7.586 | 1.538938 | 12.357808 | 4.116717 | 40.686701 |
| 8.71 | 1.730684 | 14.088492 | 3.966356 | 44.653057 |
| 10 | 1.945681 | 16.034173 | 3.718693 | 48.37175 |
| 11.482 | 2.179509 | 18.213682 | 3.411068 | 51.782818 |
| 13.183 | 2.441672 | 20.655354 | 3.070974 | 54.853792 |
| 15.136 | 2.726739 | 23.382093 | 2.745314 | 57.599106 |
| 17.378 | 3.040401 | 26.422494 | 2.460716 | 60.059822 |
| 19.953 | 3.37107 | 29.793564 | 2.247682 | 62.307504 |
| 22.909 | 3.713497 | 33.507061 | 2.114532 | 64.422036 |
| 26.303 | 4.046694 | 37.553755 | 2.061634 | 66.48367 |
| 30.2 | 4.353806 | 41.907561 | 2.073767 | 68.557437 |
| 34.674 | 4.610148 | 46.517709 | 2.125966 | 70.683403 |
| 39.811 | 4.794615 | 51.312324 | 2.186207 | 72.86961 |
| 45.709 | 4.886992 | 56.199316 | 2.219855 | 75.089465 |
| 52.481 | 4.872915 | 61.072231 | 2.196694 | 77.286159 |
| 60.256 | 4.746624 | 65.818855 | 2.098508 | 79.384667 |
| 69.183 | 4.515383 | 70.334238 | 1.925367 | 81.310034 |
| 79.433 | 4.195044 | 74.529282 | 1.69069 | 83.000724 |
| 91.201 | 3.818514 | 78.347796 | 1.426562 | 84.427286 |
| 104.713 | 3.409404 | 81.7572 | 1.166639 | 85.593925 |
| 120.223 | 3.002268 | 84.759468 | 0.958878 | 86.552803 |
| 138.038 | 2.605601 | 87.365069 | 0.839074 | 87.391877 |
| 158.489 | 2.241022 | 89.606091 | 0.839625 | 88.231502 |
| 181.97 | 1.903499 | 91.50959 | 0.971548 | 89.20305 |
| 208.93 | 1.607127 | 93.116717 | 1.213745 | 90.416795 |
| 239.883 | 1.345907 | 94.462624 | 1.521361 | 91.938156 |
| 275.423 | 1.126735 | 95.589359 | 1.801732 | 93.739888 |
| 316.228 | 0.941362 | 96.530721 | 1.954826 | 95.694714 |
| 363.078 | 0.787988 | 97.318709 | 1.873359 | 97.568073 |
| 416.869 | 0.655751 | 97.97446 | 1.506637 | 99.07471 |
| 478.63 | 0.535626 | 98.510086 | 0.807756 | 99.882466 |
| 549.541 | 0.4197 | 98.929786 | 0.117534 | 100 |
| 630.957 | 0.296119 | 99.225905 | 0 | 100 |
| 724.436 | 0.198874 | 99.424779 | 0 | 100 |
| 831.764 | 0.170126 | 99.594905 | 0 | 100 |
| 954.993 | 0.142548 | 99.737453 | 0 | 100 |
| 1096.48 | 0.109731 | 99.847184 | 0 | 100 |
| 1258.93 | 0.076033 | 99.923217 | 0 | 100 |
| 1445.44 | 0.048199 | 99.971416 | 0 | 100 |
| 1659.59 | 0.023356 | 99.994772 | 0 | 100 |
| 1905.46 | 0.005231 | 100.000003 | 0 | 100 |

The volume weighted mean, specific surface area, surface weighted mean, and d(0.1), d(0.5), and d(0.9) values for 1A and 1B are provided in Table 2.

TABLE 2

| | 1A (Comparative) | 1B (Inventive) |
|---|---|---|
| Volume Weighted Mean (μm) | 83.289 | 60.75 |
| Specific Surface Area (m²/g) | 0.387 | 1.03 |
| Surface Weighted Mean (μm) | 15.511 | 5.853 |
| d(0.1) (μm) | 6.996 | 2.523 |
| d(0.5) (μm) | 44.029 | 12.244 |
| d(0.9) (μm) | 186.907 | 229.582 |

As shown in Tables 1 and 2, dry grinding of the gypsum resulted in a material generally having a reduced median particle size compared to the gypsum used as received. Further, the ground gypsum 1B displayed smaller d(0.1) and d(0.5) values, volume weighted mean, and surface weighted mean than the as received gypsum 1A. The ground gypsum 1B also displayed a greater specific surface area compared to as received gypsum 1A. However, the d(0.9) value reported for ground gypsum 1B was apparently greater than for gypsum 1A.

Based on studies of dry grinding similar materials, it was determined that the particle size measurements from the Malvern Instrument did not accurately correct for agglomeration. More particularly, the reported particle size measurement gave a higher percentage of large particle size fractions relative to the unground material. The particle size data was corrected using the following procedure. The agglomeration peak from the coarser size fraction of the plot was replaced with a smooth size distribution of similar feed materials having a finer size fraction. Then the percentage particle size fraction was recalculated while holding the whole particle size distribution area to be 100%. The cumulative particle size distribution was recalculated as shown in Tables 3 and 4. All other data (volume weighted mean, specific surface area, surface weighted mean, d(0.1), d (0.5), and d(0.9)) were proportionally calculated using the corrected data.

TABLE 3

| | | Cumulative | | |
|---|---|---|---|---|
| Size | Volume % | Volume % | Volume % | Cumulative |
| (μm) | 1C | 1C | 1D | Volume % 1D |
| 0.275 | 0.000000 | 0.000000 | 0.000000 | 0.000000 |
| 0.316 | 0.000000 | 0.000000 | 0.012561 | 0.012561 |
| 0.363 | 0.000000 | 0.000000 | 0.116188 | 0.128749 |
| 0.417 | 0.000000 | 0.000000 | 0.161438 | 0.290187 |
| 0.479 | 0.000000 | 0.000000 | 0.210890 | 0.501077 |
| 0.55 | 0.000000 | 0.000000 | 0.262360 | 0.763437 |
| 0.631 | 0.000000 | 0.000000 | 0.318783 | 1.082220 |
| 0.724 | 0.061787 | 0.061787 | 0.380331 | 1.462551 |
| 0.832 | 0.15896 | 0.220747 | 0.452566 | 1.915117 |
| 0.955 | 0.263403 | 0.48415 | 0.537834 | 2.452951 |
| 1.096 | 0.332117 | 0.816267 | 0.643960 | 3.096911 |
| 1.259 | 0.39953 | 1.215797 | 0.775018 | 3.871929 |
| 1.445 | 0.454374 | 1.670171 | 0.939862 | 4.811791 |
| 1.66 | 0.502406 | 2.172577 | 1.141817 | 5.953608 |
| 1.905 | 0.545304 | 2.717881 | 1.387883 | 7.341491 |
| 2.188 | 0.587779 | 3.30566 | 1.679336 | 9.020827 |
| 2.512 | 0.634723 | 3.940383 | 2.018203 | 11.039030 |
| 2.884 | 0.690592 | 4.630975 | 2.398562 | 13.437592 |
| 3.311 | 0.759639 | 5.390614 | 2.809269 | 16.246861 |
| 3.802 | 0.844167 | 6.234781 | 3.235177 | 19.482038 |
| 4.365 | 0.946914 | 7.181695 | 3.648423 | 23.130461 |
| 5.012 | 1.06719 | 8.248885 | 4.024112 | 27.154573 |
| 5.754 | 1.206987 | 9.455872 | 4.326978 | 31.481551 |
| 6.607 | 1.362998 | 10.81887 | 4.533404 | 36.014956 |
| 7.586 | 1.538938 | 12.357808 | 4.618360 | 40.633316 |
| 8.71 | 1.730684 | 14.088492 | 4.574130 | 45.207446 |
| 10 | 1.945681 | 16.034173 | 4.407062 | 49.614508 |
| 11.482 | 2.179509 | 18.213682 | 4.131881 | 53.746389 |
| 13.183 | 2.441672 | 20.655354 | 3.790076 | 57.536464 |
| 15.136 | 2.726739 | 23.382093 | 3.412193 | 60.948658 |
| 17.378 | 3.040401 | 26.422494 | 3.050349 | 63.999007 |
| 19.953 | 3.37107 | 29.793564 | 2.734129 | 66.733136 |
| 22.909 | 3.713497 | 33.507061 | 2.497424 | 69.230560 |
| 26.303 | 4.046694 | 37.553755 | 2.349480 | 71.580040 |
| 30.2 | 4.353806 | 41.907561 | 2.290704 | 73.870744 |
| 34.674 | 4.610148 | 46.517709 | 2.304186 | 76.174930 |
| 39.811 | 4.794615 | 51.312324 | 2.362184 | 78.537114 |
| 45.709 | 4.886992 | 56.199316 | 2.429119 | 80.966233 |
| 52.481 | 4.872915 | 61.072231 | 2.466506 | 83.432739 |
| 60.256 | 4.746624 | 65.818855 | 2.440771 | 85.873510 |
| 69.183 | 4.515383 | 70.334238 | 2.331676 | 88.205186 |
| 79.433 | 4.195044 | 74.529282 | 2.139297 | 90.344482 |
| 91.201 | 3.818514 | 78.347796 | 1.878544 | 92.223027 |
| 104.713 | 3.409404 | 81.7572 | 1.585069 | 93.808096 |
| 120.223 | 3.002268 | 84.759468 | 1.296266 | 95.104361 |
| 138.038 | 2.605601 | 87.365069 | 1.045958 | 96.150319 |
| 158.489 | 2.241022 | 89.606091 | 0.875542 | 97.025861 |
| 181.97 | 1.903499 | 91.50959 | 0.728612 | 97.754473 |
| 208.93 | 1.607127 | 93.116717 | 0.595140 | 98.349613 |
| 239.883 | 1.345907 | 94.462624 | 0.466333 | 98.815947 |
| 275.423 | 1.126735 | 95.589359 | 0.329021 | 99.144968 |
| 316.228 | 0.941362 | 96.530721 | 0.220971 | 99.365939 |
| 363.078 | 0.787988 | 97.318709 | 0.189029 | 99.554968 |
| 416.869 | 0.655751 | 97.97446 | 0.158387 | 99.713354 |
| 478.63 | 0.535626 | 98.510086 | 0.121923 | 99.835278 |
| 549.541 | 0.4197 | 98.929786 | 0.084481 | 99.919759 |
| 630.957 | 0.296119 | 99.225905 | 0.053554 | 99.973313 |
| 724.436 | 0.198874 | 99.424779 | 0.025951 | 99.999264 |
| 831.764 | 0.170126 | 99.594905 | 0.005812 | 100.005077 |
| 954.993 | 0.142548 | 99.737453 | 0.000000 | 100.005077 |
| 1096.48 | 0.109731 | 99.847184 | 0.000000 | 100.005077 |
| 1258.93 | 0.076033 | 99.923217 | 0.000000 | 100.005077 |
| 1445.44 | 0.048199 | 99.971416 | 0.000000 | 100.005077 |
| 1659.59 | 0.023356 | 99.994772 | 0.000000 | 100.005077 |
| 1905.46 | 0.005231 | 100.000003 | 0.000000 | 100.005077 |

TABLE 4

| | 1C (Comparative) | 1D (Inventive) |
|---|---|---|
| Volume Weighted Mean (μm) | 83.289 | 50.16 |
| Specific Surface Area (m²/g) | 0.387 | 1.08 |
| Surface Weighted Mean (μm) | 15.511 | 5.346 |
| d(0.1) (μm) | 6.996 | 2.047 |
| d(0.5) (μm) | 44.029 | 8.925 |
| d(0.9) (μm) | 186.907 | 68.282 |

As shown in Tables 3 and 4, dry grinding of the gypsum resulted in a material having a reduced median particle size compared to the gypsum used as received. Further, the ground gypsum 1D displayed smaller d(0.1), d(0.5), and d(0.9) values, volume weighted mean, and surface weighted mean than the as received gypsum 1C. The ground gypsum 1D also displayed a greater specific surface area compared to as received gypsum 1C.

### EXAMPLE 2

This example illustrates a process for preparing a wet gypsum accelerator according to the invention and demonstrates the effect of wet grinding time on WGA viscosity.

The gypsum materials 1A and 1B prepared in Example 1 were used to prepare two different batches of WGA (2A (comparative) and 2B (invention), respectively) using a Premier Supermill SM-15 under the following conditions: 1750 rpm, 92% bead filling, 1.2-1.4 mm ZIRCONOX™ grinding beads, 4000 mL tap water, 3000 g landplaster, 15 g sodium trimetaphosphate (STMP), and 15 g DEQUEST™ 2006. The wet grinding time was varied as indicated. Viscosity was measured as a function of wet grinding time using a Brookfield RVT viscometer operating at room temperature and ambient pressure.

The viscosity, mill power, and product pressures for WGA 2A and 2B at a series of grinding times are provided in Table 5.

TABLE 5

| | Grinding | Viscosity | Mill Power | Product |
|---|---|---|---|---|
| Sample | Time (min) | (cP) | (kW) | Pressure (psi) |
| 2A | 5 | 900 | 1.9 | 1.6 |
| (Comparative) | 10 | 2760 | 2.1 | 2.1 |
| | 13 | 4850 | 2.3 | 2.9 |
| | 15 | 6860 | 2.6 | 3.3 |
| 2B | 3 | 4900 | 2.1 | 2.5 |
| (Inventive) | 4 | 7500 | 2.3 | 2.9 |
| | 5 | 6600 | 2.3 | 3.1 |
| | 6 | 11000 | 2.7 | 4.1 |
| | 7 | 9050 | 2.6 | 4.1 |

As depicted in Table 5, the use of dry gypsum having a median particle size of less than about 20 microns to prepare WGA allowed for suitable viscosities and product pressures to be obtained with shorter grinding times. Accordingly, the shorter wet grinding times resulted in reduced power consumption of the mills.

### EXAMPLE 3

This example demonstrates the enhanced rate of hydration of WGA prepared in accordance with the present invention as compared to a climate stabilized accelerator (CSA).

WGA samples were prepared following the procedure described in Example 2 using a wet grinding time of 4 minutes (Example 3B, invention) or 6 minutes (Examples 3C and 3D, invention). Each of the samples was tested to determine the rate of hydration. The hydration rates were compared to a sample of CSA (3A, comparative), which is a set accelerator powder comprising finely ground particles of calcium sulfate dihydrate coated with sugar to maintain efficiency and heated, as described in U.S. Pat. No. 3,573,947, the disclosure of which is hereby incorporated by reference.

For each test, 300 g of calcium sulfate hemihydrate from ‘USG's East Chicago plant was combined with 300 mL of tap water (21° C.). Two grams (3A-3C) or four grams (3D) of the CSA or WGA (dry weight basis) were added to the calcium sulfate hemihydrate slurry, and the slurry was allowed to soak for 10 seconds followed by mixing for 10 seconds at low speed with a WARING™ blender. The resulting slurry was poured into a polystyrene foam cup, which was then placed into an insulated Styrofoam container to minimize heat loss to the environment during the hydration reaction. A temperature probe was placed into the middle of the slurry, and the temperature was recorded every 5 seconds. Since the setting reaction is exothermic, the extent of the reaction was measured by the temperature rise. The Time to 50% Hydration was determined to be the time to reach the temperature half-way between the initial and maximum temperatures recorded during the test.

The temperature measurements for samples 3A-3D are provided in Table 6. The Time to 50% Hydration and Time to 98% Hydration times for samples 3A-3D are provided in Table 7.

TABLE 6

| | | | | Temp. (° C.) |
|---|---|---|---|---|
| Time | Temp. (° C.) | Temp. (° C.) | Temp. (° C.) | 3D |
| (s) | 3A (Comparative) | 3B (Inventive) | 3C (Inventive) | (Inventive) |
| 10 | 72.36 | 71.98 | 72.31 | 71.88 |
| 15 | 73.63 | 71.97 | 73.35 | 73.24 |
| 20 | 73.89 | 73.71 | 73.67 | 73.80 |
| 25 | 74.03 | 74.28 | 73.82 | 74.00 |
| 30 | 74.12 | 74.53 | 73.95 | 74.18 |
| 35 | 74.22 | 74.68 | 74.09 | 74.34 |
| 40 | 74.31 | 74.80 | 74.20 | 74.50 |
| 45 | 74.35 | 74.96 | 74.33 | 74.70 |
| 50 | 74.44 | 75.10 | 74.42 | 74.87 |
| 55 | 74.51 | 75.19 | 74.55 | 75.08 |
| 60 | 74.58 | 75.31 | 74.65 | 75.26 |
| 65 | 74.63 | 75.44 | 74.79 | 75.47 |
| 70 | 74.75 | 75.54 | 74.92 | 75.66 |
| 75 | 74.81 | 75.69 | 75.05 | 75.89 |
| 80 | 74.89 | 75.80 | 75.16 | 76.10 |
| 85 | 74.95 | 75.91 | 75.30 | 76.31 |
| 90 | 75.03 | 76.06 | 75.45 | 76.57 |
| 95 | 75.13 | 76.15 | 75.57 | 76.81 |
| 100 | 75.22 | 76.29 | 75.69 | 77.07 |
| 105 | 75.31 | 76.41 | 75.85 | 77.31 |
| 110 | 75.42 | 76.56 | 76.02 | 77.57 |
| 115 | 75.52 | 76.70 | 76.16 | 77.83 |
| 120 | 75.62 | 76.82 | 76.32 | 78.10 |
| 125 | 75.72 | 76.98 | 76.51 | 78.40 |
| 130 | 75.84 | 77.12 | 76.66 | 78.71 |
| 135 | 75.93 | 77.30 | 76.81 | 78.98 |
| 140 | 76.06 | 77.45 | 77.03 | 79.33 |
| 145 | 76.18 | 77.60 | 77.19 | 79.64 |
| 150 | 76.32 | 77.76 | 77.40 | 79.95 |
| 155 | 76.44 | 77.94 | 77.60 | 80.31 |
| 160 | 76.59 | 78.14 | 77.78 | 80.67 |
| 165 | 76.74 | 78.28 | 78.01 | 80.96 |
| 170 | 76.88 | 78.49 | 78.22 | 81.34 |
| 175 | 77.03 | 78.68 | 78.40 | 81.73 |
| 180 | 77.20 | 78.90 | 78.67 | 82.14 |
| 185 | 77.36 | 79.07 | 78.88 | 82.51 |
| 190 | 77.55 | 79.28 | 79.14 | 82.90 |
| 195 | 77.70 | 79.50 | 79.38 | 83.34 |
| 200 | 77.90 | 79.70 | 79.61 | 83.74 |
| 205 | 78.08 | 79.94 | 79.89 | 84.21 |
| 210 | 78.26 | 80.22 | 80.16 | 84.65 |
| 215 | 78.52 | 80.40 | 80.44 | 85.09 |
| 220 | 78.71 | 80.66 | 80.70 | 85.58 |
| 225 | 78.94 | 80.91 | 80.98 | 86.06 |
| 230 | 79.18 | 81.13 | 81.31 | 86.52 |
| 235 | 79.39 | 81.44 | 81.60 | 87.05 |
| 240 | 79.65 | 81.71 | 81.86 | 87.62 |
| 245 | 79.91 | 81.97 | 82.22 | 88.13 |
| 250 | 80.16 | 82.28 | 82.59 | 88.68 |
| 255 | 80.43 | 82.58 | 82.93 | 89.27 |
| 260 | 80.71 | 82.87 | 83.25 | 89.86 |
| 265 | 80.97 | 83.18 | 83.64 | 90.42 |
| 270 | 81.30 | 83.50 | 84.03 | 91.05 |
| 275 | 81.59 | 83.86 | 84.37 | 91.71 |
| 280 | 81.92 | 84.15 | 84.78 | 92.31 |
| 285 | 82.24 | 84.50 | 85.19 | 93.03 |
| 290 | 82.57 | 84.86 | 85.58 | 93.75 |
| 295 | 82.93 | 85.21 | 86.01 | 94.45 |
| 300 | 83.27 | 85.62 | 86.44 | 95.19 |
| 305 | 83.69 | 86.01 | 86.85 | 95.97 |
| 310 | 84.06 | 86.40 | 87.31 | 96.66 |
| 315 | 84.43 | 86.78 | 87.85 | 97.48 |
| 320 | 84.84 | 87.22 | 88.28 | 98.24 |
| 325 | 85.26 | 87.68 | 88.79 | 98.91 |
| 330 | 85.66 | 88.09 | 89.33 | 99.55 |
| 335 | 86.12 | 88.54 | 89.86 | 100.13 |
| 340 | 86.60 | 89.02 | 90.36 | 100.61 |
| 345 | 87.08 | 89.49 | 90.92 | 100.93 |
| 350 | 87.50 | 89.97 | 91.56 | 101.29 |
| 355 | 88.03 | 90.50 | 92.05 | 101.52 |
| 360 | 88.52 | 90.96 | 92.71 | 101.74 |
| 365 | 89.06 | 91.53 | 93.35 | 101.94 |
| 370 | 89.58 | 92.10 | 93.96 | 102.12 |
| 375 | 90.15 | 92.61 | 94.65 | 102.24 |
| 380 | 90.68 | 93.19 | 95.39 | 102.37 |
| 385 | 91.28 | 93.85 | 96.05 | 102.47 |
| 390 | 91.91 | 94.41 | 96.80 | 102.54 |
| 395 | 92.50 | 95.07 | 97.56 | 102.64 |
| 400 | 93.17 | 95.78 | 98.25 | 102.71 |
| 405 | 93.85 | 96.45 | 98.97 | 102.78 |
| 410 | 94.50 | 97.11 | 99.71 | 102.84 |
| 415 | 95.23 | 97.82 | 100.34 | 102.90 |
| 420 | 96.02 | 98.55 | 100.82 | 102.94 |
| 425 | 96.77 | 99.17 | 101.28 | 102.97 |
| 430 | 97.51 | 99.90 | 101.62 | 103.00 |
| 435 | 98.31 | 100.51 | 101.93 | 103.02 |
| 440 | 99.13 | 101.00 | 102.19 | 103.05 |
| 445 | 99.82 | 101.50 | 102.40 | 103.07 |
| 450 | 100.54 | 101.88 | 102.59 | 103.07 |
| 455 | 101.21 | 102.22 | 102.73 | 103.10 |
| 460 | 101.74 | 102.50 | 102.91 | 103.10 |
| 465 | 102.22 | 102.74 | 102.99 | 103.13 |
| 470 | 102.63 | 102.97 | 103.09 | 103.13 |
| 475 | 102.93 | 103.12 | 103.19 | 103.14 |
| 480 | 103.21 | 103.29 | 103.29 | 103.15 |
| 485 | 103.47 | 103.44 | 103.35 | 103.13 |
| 490 | 103.68 | 103.54 | 103.39 | 103.16 |
| 495 | 103.86 | 103.65 | 103.49 | 103.12 |
| 500 | 104.01 | 103.76 | 103.53 | 103.16 |
| 505 | 104.17 | 103.81 | 103.57 | 103.13 |
| 510 | 104.27 | 103.90 | 103.61 | 103.12 |
| 515 | 104.38 | 103.97 | 103.65 | 103.14 |
| 520 | 104.52 | 104.01 | 103.66 | 103.11 |
| 525 | 104.59 | 104.08 | 103.70 | 103.12 |
| 530 | 104.68 | 104.12 | 103.73 | 103.11 |
| 535 | 104.76 | 104.15 | 103.75 | 103.12 |
| 540 | 104.80 | 104.18 | 103.78 | 103.09 |
| 545 | 104.87 | 104.22 | 103.77 | 103.07 |
| 550 | 104.93 | 104.27 | 103.79 | 103.09 |
| 555 | 104.96 | 104.27 | 103.82 | 103.06 |
| 560 | 105.01 | 104.31 | 103.84 | 103.08 |
| 565 | 105.06 | 104.33 | 103.82 | 103.03 |
| 570 | 105.08 | 104.36 | 103.85 | 103.02 |
| 575 | 105.12 | 104.35 | 103.87 | 103.04 |
| 580 | 105.15 | 104.39 | 103.86 | 103.03 |
| 585 | 105.17 | 104.40 | 103.84 | 102.99 |
| 590 | 105.17 | 104.39 | 103.87 | 102.99 |
| 595 | 105.22 | 104.40 | 103.87 | 102.96 |
| 600 | 105.23 | 104.40 | 103.85 | 102.97 |
| 605 | 105.25 | 104.42 | 103.89 | 102.95 |
| 610 | 105.25 | 104.40 | 103.87 | 102.95 |
| 615 | 105.24 | 104.45 | 103.85 | 102.94 |
| 620 | 105.29 | 104.44 | 103.87 | 102.94 |
| 625 | 105.28 | 104.41 | 103.86 | 102.88 |
| 630 | 105.31 | 104.43 | 103.87 | 102.89 |
| 635 | 105.29 | 104.40 | 103.85 | 102.86 |
| 640 | 105.28 | 104.45 | 103.85 | 102.87 |
| 645 | 105.31 | 104.44 | 103.86 | 102.85 |
| 650 | 105.29 | 104.44 | 103.85 | 102.83 |
| 655 | 105.30 | 104.42 | 103.82 | 102.80 |
| 660 | 105.29 | 104.38 | 103.84 | 102.80 |
| 665 | 105.30 | 104.40 | 103.82 | 102.74 |
| 670 | 105.29 | 104.40 | 103.80 | 102.75 |
| 675 | 105.30 | 104.40 | 103.80 | 102.71 |
| 680 | 105.31 | 104.40 | 103.80 | 102.72 |
| 685 | 105.28 | 104.38 | 103.79 | 102.68 |
| 690 | 105.28 | 104.39 | 103.77 | 102.70 |
| 695 | 105.27 | 104.39 | 103.77 | 102.67 |
| 700 | 105.26 | 104.38 | 103.77 | 102.62 |
| 705 | 105.25 | 104.36 | 103.75 | 102.65 |
| 710 | 105.22 | 104.38 | 103.70 | 102.58 |
| 715 | 105.24 | 104.38 | 103.73 | 102.57 |
| 720 | 105.23 | 104.36 | 103.72 | 102.56 |
| 725 | 105.22 | 104.35 | 103.71 | 102.56 |
| 730 | 105.19 | 104.33 | 103.73 | 102.56 |
| 735 | 105.19 | 104.34 | 103.68 | 102.52 |
| 740 | 105.17 | 104.32 | 103.65 | 102.48 |
| 745 | 105.16 | 104.30 | 103.67 | 102.48 |
| 750 | 105.16 | 104.29 | 103.65 | 102.46 |
| 755 | 105.14 | 104.28 | | 102.46 |
| 760 | 105.14 | 104.27 | | 102.42 |
| 765 | 105.11 | 104.27 | | 102.41 |
| 770 | 105.10 | 104.26 | | 102.40 |
| 775 | 105.10 | 104.23 | | 102.38 |
| 780 | 105.08 | 104.20 | | 102.34 |
| 785 | 105.05 | 104.22 | | 102.32 |
| 790 | 105.07 | 104.21 | | 102.33 |
| 795 | 105.02 | 104.19 | | 102.29 |
| 800 | 105.04 | 104.17 | | |
| 805 | 105.00 | 104.18 | | |
| 810 | | 104.17 | | |
| 815 | | 104.15 | | |
| 820 | | 104.16 | | |
| 825 | | 104.13 | | |

TABLE 7

| | 3A | 3B | 3C | 3D |
|---|---|---|---|---|
| | (Comparative) | (Inventive) | (Inventive) | (Inventive) |
| Time to | 370 s | 340 s | 325 s | 245 s |
| 50% | | | | |
| Hydration | | | | |
| Time to | 530 s | 505 s | 480 s | 390 s |
| 98% | | | | |
| Hydration | | | | |

As seen in Table 7, wet gypsum accelerators prepared in accordance with the present invention (samples 3B-3D) each have shorter Time to 50% Hydration and Time to 98% Hydration times as compared to CSA (sample 3A), thus illustrating the enhanced efficiency of the inventive method and process. In addition, samples 3C and 3D, which were prepared using a wet grinding time of 6 min, displayed a shorter Time to 50% Hydration than sample 3B, which was prepared using a wet grinding time of 4 minutes. This inverse relationship between Time to 50% Hydration and wet grinding time is indicative of a WGA with a smaller median particle size, thereby having a greater efficiency.

### EXAMPLE 4

This example illustrates that set gypsum-containing compositions prepared in accordance with the present invention have comparable compressive strength to set gypsum-containing composition prepared using a CSA.

Samples 4A (comparative) and 4B-4D (invention) were prepared by casting 2 g of WGA samples 3A-3D, respectively, with 800 g of calcium sulfate hemihydrate (stucco) (USG East Chicago plant). The samples were mixed with 1000 mL tap water in a 2 L WARING™ blender, allowed to soak for 5 seconds and mixed at low speed for 10 seconds. The slurries thus formed were cast into molds to prepare cubes (2 inches per side). After the calcium sulfate hemihydrate set to form gypsum (calcium sulfate dihydrate), the cubes were removed from the molds and dried in a ventilated oven at 44° C. for at least 72 hours or until the samples reached a constant weight. Each dry cube's compressive strength was measured on a SATEC testing machine, in accordance with ASTM C472-93.

The sample weight, density, applied load, and compressive strength for each of samples 4A-4D are provided in Table 8 as average values of triplicate measurements.

TABLE 8

| | | Sample | | Compressive |
|---|---|---|---|---|
| | Sample | Density | Applied | Strength |
| Sample | Weight (g) | (kg/m³) | Load (kJ) | (MPa) |
| 4A | 94.62 ± 0.217 | 721.31 ± 1.65 | 4.94 ± 0.0528 | 6.29 ± 0.067 |
| (Com- | | | | |
| par- | | | | |
| ative) | | | | |
| 4B | 93.97 ± 0.156 | 716.67 ± 1.19 | 5.06 ± 0.0938 | 6.44 ± 0.12 |
| (Inven- | | | | |
| tive) | | | | |
| 4C | 93.89 ± 0.270 | 716.83 ± 2.07 | 4.43 ± 0.267 | 5.63 ± 0.34 |
| (Inven- | | | | |
| tive) | | | | |
| 4D | 92.76 ± 0.100 | 707.22 ± 0.77 | 4.60 ± 0.225 | 5.85 ± 0.29 |
| (Inven- | | | | |
| tive) | | | | |

As is shown in Table 8, set gypsum-containing compositions prepared in accordance with the invention have comparable, or in the case of Sample 4B, superior compressive strength as compared to set gypsum containing compositions prepared using CSA (Sample 4A).

### EXAMPLE 5

This example illustrates that WGA prepared in accordance with the invention provides an enhanced rate of hydration compared to a climate stabilized accelerator (CSA).

WGA was prepared according to the procedure described in Example 3 using a wet grinding time of 3 min (5B), 5 min (5C), or 7 min (5D). The hydration rates were tested and compared to a CSA (5A, comparative) as described in Example 3, except that Southard landplaster was used and temperature measurements were taken every 6 seconds.

The temperature measurements for samples 5A-5D are provided in Table 9. The Time to 50% Hydration and Time to 98% Hydration times for samples 5A-5D are provided in Table 10.

TABLE 9

| | Temp | Temp | Temp | Temp |
|---|---|---|---|---|
| | (° C.) 5A | (° C.) 5B | (° C.) 5C | (° C.) 5D |
| Time (min) | (Comparative) | (Inventive) | (Inventive) | (Inventive) |
| 0.2 | 73.9 | 71.7 | 71.6 | 71.9 |
| 0.3 | 74.3 | 74.8 | 73.7 | 74.6 |
| 0.3 | 74.4 | 75.5 | 75.4 | 75.2 |
| 0.4 | 74.5 | 75.7 | 75.6 | 75.3 |
| 0.5 | 74.6 | 75.9 | 75.8 | 75.4 |
| 0.6 | 74.7 | 76.0 | 75.9 | 75.5 |
| 0.7 | 74.7 | 76.1 | 75.9 | 75.6 |
| 0.8 | 74.8 | 76.2 | 76.0 | 75.7 |
| 0.8 | 74.9 | 76.2 | 76.1 | 75.8 |
| 0.9 | 74.9 | 76.4 | 76.2 | 75.9 |
| 1.0 | 75.0 | 76.4 | 76.3 | 76.0 |
| 1.1 | 75.1 | 76.5 | 76.4 | 76.1 |
| 1.2 | 75.2 | 76.6 | 76.5 | 76.2 |
| 1.3 | 75.3 | 76.7 | 76.6 | 76.3 |
| 1.3 | 75.3 | 76.8 | 76.6 | 76.4 |
| 1.4 | 75.4 | 76.9 | 76.7 | 76.5 |
| 1.5 | 75.5 | 77.0 | 76.9 | 76.7 |
| 1.6 | 75.6 | 77.1 | 77.0 | 76.8 |
| 1.7 | 75.7 | 77.2 | 77.1 | 76.9 |
| 1.8 | 75.8 | 77.3 | 77.2 | 77.0 |
| 1.8 | 75.9 | 77.4 | 77.3 | 77.2 |
| 1.9 | 76.0 | 77.5 | 77.4 | 77.3 |
| 2.0 | 76.1 | 77.6 | 77.5 | 77.4 |
| 2.1 | 76.2 | 77.7 | 77.7 | 77.6 |
| 2.2 | 76.3 | 77.8 | 77.8 | 77.8 |
| 2.3 | 76.4 | 78.0 | 77.9 | 77.9 |
| 2.3 | 76.5 | 78.1 | 78.1 | 78.1 |
| 2.4 | 76.7 | 78.3 | 78.2 | 78.2 |
| 2.5 | 76.8 | 78.4 | 78.4 | 78.4 |
| 2.6 | 76.9 | 78.6 | 78.5 | 78.6 |
| 2.7 | 77.0 | 78.7 | 78.7 | 78.7 |
| 2.8 | 77.2 | 78.8 | 78.8 | 79.0 |
| 2.8 | 77.4 | 78.9 | 79.0 | 79.1 |
| 2.9 | 77.5 | 79.1 | 79.2 | 79.3 |
| 3.0 | 77.7 | 79.3 | 79.4 | 79.5 |
| 3.1 | 77.8 | 79.4 | 79.5 | 79.7 |
| 3.2 | 78.0 | 79.6 | 79.7 | 80.0 |
| 3.3 | 78.2 | 79.8 | 79.9 | 80.2 |
| 3.3 | 78.4 | 80.0 | 80.1 | 80.4 |
| 3.4 | 78.6 | 80.2 | 80.3 | 80.7 |
| 3.5 | 78.8 | 80.3 | 80.5 | 80.9 |
| 3.6 | 79.0 | 80.6 | 80.7 | 81.1 |
| 3.7 | 79.2 | 80.8 | 80.9 | 81.3 |
| 3.8 | 79.4 | 81.0 | 81.2 | 81.6 |
| 3.8 | 79.7 | 81.2 | 81.4 | 81.9 |
| 3.9 | 79.9 | 81.4 | 81.7 | 82.1 |
| 4.0 | 80.1 | 81.6 | 81.9 | 82.4 |
| 4.1 | 80.4 | 81.9 | 82.1 | 82.7 |
| 4.2 | 80.6 | 82.1 | 82.4 | 83.0 |
| 4.3 | 80.9 | 82.3 | 82.7 | 83.3 |
| 4.3 | 81.2 | 82.6 | 82.9 | 83.6 |
| 4.4 | 81.5 | 82.8 | 83.1 | 83.9 |
| 4.5 | 81.8 | 83.1 | 83.5 | 84.2 |
| 4.6 | 82.1 | 83.3 | 83.7 | 84.5 |
| 4.7 | 82.4 | 83.6 | 84.0 | 84.8 |
| 4.8 | 82.7 | 83.9 | 84.3 | 85.2 |
| 4.8 | 83.1 | 84.1 | 84.6 | 85.5 |
| 4.9 | 83.4 | 84.4 | 84.9 | 85.8 |
| 5.0 | 83.8 | 84.7 | 85.3 | 86.2 |
| 5.1 | 84.2 | 85.0 | 85.6 | 86.6 |
| 5.2 | 84.5 | 85.3 | 85.9 | 87.0 |
| 5.3 | 84.9 | 85.7 | 86.3 | 87.4 |
| 5.3 | 85.3 | 86.0 | 86.6 | 87.8 |
| 5.4 | 85.8 | 86.3 | 87.0 | 88.2 |
| 5.5 | 86.2 | 86.6 | 87.3 | 88.6 |
| 5.6 | 86.6 | 87.0 | 87.7 | 89.0 |
| 5.7 | 87.1 | 87.4 | 88.1 | 89.4 |
| 5.8 | 87.6 | 87.7 | 88.5 | 89.9 |
| 5.8 | 88.0 | 88.0 | 88.9 | 90.3 |
| 5.9 | 88.5 | 88.4 | 89.3 | 90.8 |
| 6.0 | 89.0 | 88.8 | 89.7 | 91.3 |
| 6.1 | 89.6 | 89.2 | 90.1 | 91.8 |
| 6.2 | 90.1 | 89.6 | 90.6 | 92.3 |
| 6.3 | 90.6 | 90.0 | 91.0 | 92.8 |
| 6.3 | 91.2 | 90.4 | 91.5 | 93.3 |
| 6.4 | 91.8 | 90.8 | 92.0 | 93.9 |
| 6.5 | 92.4 | 91.3 | 92.4 | 94.4 |
| 6.6 | 93.0 | 91.7 | 92.9 | 95.0 |
| 6.7 | 93.6 | 92.2 | 93.5 | 95.6 |
| 6.8 | 94.3 | 92.7 | 93.9 | 96.2 |
| 6.8 | 95.0 | 93.1 | 94.5 | 96.7 |
| 6.9 | 95.7 | 93.6 | 95.0 | 97.4 |
| 7.0 | 96.4 | 94.2 | 95.7 | 98.0 |
| 7.1 | 97.2 | 94.7 | 96.2 | 98.6 |
| 7.2 | 97.9 | 95.2 | 96.8 | 99.2 |
| 7.3 | 98.6 | 95.8 | 97.3 | 99.8 |
| 7.3 | 99.3 | 96.4 | 97.9 | 100.4 |
| 7.4 | 100.0 | 96.9 | 98.5 | 101.0 |
| 7.5 | 100.5 | 97.5 | 99.2 | 101.5 |
| 7.6 | 101.1 | 98.2 | 99.7 | 102.0 |
| 7.7 | 101.5 | 98.7 | 100.3 | 102.4 |
| 7.8 | 101.9 | 99.3 | 100.9 | 102.7 |
| 7.8 | 102.2 | 99.9 | 101.4 | 103.0 |
| 7.9 | 102.5 | 100.5 | 101.9 | 103.2 |
| 8.0 | 102.7 | 101.1 | 102.4 | 103.4 |
| 8.1 | 103.0 | 101.7 | 102.8 | 103.7 |
| 8.2 | 103.2 | 102.3 | 103.1 | 103.8 |
| 8.3 | 103.3 | 102.8 | 103.4 | 103.9 |
| 8.3 | 103.5 | 103.3 | 103.6 | 104.0 |
| 8.4 | 103.6 | 103.7 | 103.8 | 104.1 |
| 8.5 | 103.7 | 104.1 | 104.0 | 104.2 |
| 8.6 | 103.8 | 104.4 | 104.2 | 104.3 |
| 8.7 | 103.9 | 104.6 | 104.3 | 104.4 |
| 8.8 | 104.0 | 104.9 | 104.4 | 104.4 |
| 8.8 | 104.0 | 105.1 | 104.5 | 104.5 |
| 8.9 | 104.1 | 105.2 | 104.6 | 104.6 |
| 9.0 | 104.2 | 105.3 | 104.7 | 104.6 |
| 9.1 | 104.2 | 105.5 | 104.8 | 104.6 |
| 9.2 | 104.3 | 105.6 | 104.8 | 104.7 |
| 9.3 | 104.3 | 105.7 | 104.9 | 104.7 |
| 9.3 | 104.3 | 105.8 | 105.0 | 104.7 |
| 9.4 | 104.3 | 105.9 | 105.0 | 104.8 |
| 9.5 | 104.4 | 105.9 | 105.0 | 104.8 |
| 9.6 | 104.4 | 106.0 | 105.0 | 104.8 |
| 9.7 | 104.4 | 106.0 | 105.1 | 104.8 |
| 9.8 | 104.4 | 106.1 | 105.1 | 104.9 |
| 9.8 | 104.4 | 106.1 | 105.1 | 104.9 |
| 9.9 | 104.4 | 106.2 | 105.2 | 104.9 |
| 10.0 | 104.4 | 106.2 | 105.2 | 104.9 |
| 10.1 | 104.5 | 106.2 | 105.2 | 104.9 |
| 10.2 | 104.5 | 106.3 | 105.2 | 104.9 |
| 10.3 | 104.4 | 106.3 | 105.2 | 104.9 |
| 10.3 | 104.4 | 106.3 | 105.2 | 105.0 |
| 10.4 | 104.4 | 106.3 | 105.2 | 104.9 |
| 10.5 | 104.4 | 106.3 | 105.3 | 105.0 |
| 10.6 | 104.4 | 106.4 | 105.3 | 105.0 |
| 10.7 | 104.4 | 106.4 | 105.2 | 105.0 |
| 10.8 | 104.4 | 106.4 | 105.3 | 104.9 |
| 10.8 | 104.4 | 106.4 | 105.2 | 105.0 |
| 10.9 | 104.4 | 106.4 | 105.3 | 105.0 |
| 11.0 | 104.4 | 106.4 | 105.3 | 105.0 |
| 11.1 | 104.4 | 106.4 | 105.3 | 105.0 |
| 11.2 | 104.3 | 106.4 | 105.3 | 105.0 |
| 11.3 | 104.3 | 106.4 | 105.2 | 105.0 |
| 11.3 | 104.3 | 106.4 | 105.3 | 105.0 |
| 11.4 | 104.3 | 106.4 | 105.2 | 105.0 |
| 11.5 | 104.3 | 106.4 | 105.2 | 105.0 |
| 11.6 | 104.3 | 106.4 | 105.2 | 105.0 |
| 11.7 | 104.2 | 106.4 | 105.2 | 105.0 |
| 11.8 | 104.2 | 106.3 | 105.2 | 104.9 |
| 11.8 | 104.2 | 106.3 | 105.2 | 105.0 |
| 11.9 | 104.2 | 106.3 | 105.2 | 104.9 |
| 12.0 | 104.2 | 106.3 | 105.2 | 104.9 |
| 12.1 | 104.1 | 106.3 | 105.2 | 104.9 |
| 12.2 | 104.1 | 106.3 | 105.2 | 104.9 |
| 12.3 | 104.1 | 106.3 | 105.2 | 104.9 |
| 12.3 | 104.1 | 106.2 | 105.2 | 104.9 |
| 12.4 | 104.0 | 106.2 | 105.2 | 104.9 |
| 12.5 | 104.0 | 106.2 | 105.2 | 104.9 |
| 12.6 | 104.0 | 106.2 | 105.1 | 104.9 |
| 12.7 | 104.0 | 106.2 | 105.1 | 104.9 |
| 12.8 | 103.9 | 106.2 | 105.1 | 104.9 |
| 12.8 | 103.9 | 106.2 | 105.1 | 104.9 |
| 12.9 | 103.9 | 106.1 | 105.1 | 104.9 |
| 13.0 | 103.8 | 106.1 | 105.1 | 104.9 |
| 13.1 | 103.8 | 106.1 | 105.1 | 104.8 |
| 13.2 | 103.8 | 106.1 | 105.1 | 104.9 |
| 13.3 | 103.8 | 106.1 | 105.0 | 104.9 |
| 13.3 | | 106.0 | 105.1 | 104.8 |
| 13.4 | | 106.0 | 105.0 | 104.8 |
| 13.5 | | 106.0 | 105.0 | 104.8 |
| 13.6 | | 106.0 | 105.0 | 104.8 |
| 13.7 | | 105.9 | 105.0 | 104.8 |
| 13.8 | | 105.9 | 105.0 | 104.8 |
| 13.8 | | | 104.9 | |
| 13.9 | | | 105.0 | |
| 14.0 | | | 104.9 | |
| 14.1 | | | 104.9 | |
| 14.2 | | | 104.9 | |

TABLE 10

| | 5A | 5B | 5C | 5D |
|---|---|---|---|---|
| | (Comparative) | (Inventive) | (Inventive) | (Inventive) |
| Time to 50% | 365 s | 385 s | 364 s | 345 s |
| Hydration | | | | |
| Time to 98% | 520 s | 559 s | 528 s | 520 s |
| Hydration | | | | |

As shown in Table 10, samples 5B-5D have at least comparable Time to 50% Hydration and Time to 98% Hydration times compared to CSA (5A). In the case of 5C and 5D, the hydration times are reduced compared to CSA (5A).

### EXAMPLE 6

This example illustrates that set gypsum-containing compositions prepared in accordance with the present invention have a compressive strength that is comparable to or better than set gypsum-containing composition prepared using CSA.

Test samples 6A (comparative) and 6B-6D (invention) were prepared as described in Example 4 using samples 5A-5D prepared from Southard landplaster. The sample weight, density, applied load, and compressive strength for each of samples 6A-6D are provided in Table 10 as average values of triplicate measurements.

TABLE 11

| | | | | Comparative |
|---|---|---|---|---|
| | Sample | Density | Applied | Strength |
| Sample | Weight (g) | (kg/m³) | Load (kJ) | (MPa) |
| 6A | 94.62 ± 0.217 | 721.31 ± 1.65 | 4.94 ± 0.0528 | 6.29 ± 0.067 |
| (Com- | | | | |
| par- | | | | |
| ative) | | | | |
| 6B | 95.73 ± 0.522 | 729.48 ± 3.97 | 5.22 ± .00793 | 6.63 ± 0.10 |
| (Inven- | | | | |
| tive) | | | | |
| 6C | 95.53 ± 0.340 | 728.52 ± 2.59 | 5.05 ± 0.178 | 6.42 ± 0.23 |
| (Inven- | | | | |
| tive) | | | | |
| 6D | 95.13 ± 0.223 | 724.84 ± 1.70 | 5.27 ± 0.155 | 6.70 ± 0.20 |
| (Inven- | | | | |
| tive) | | | | |

As is shown in Table 11, set gypsum-containing composition of the present invention (6B-6D) have increased compressive strength as compared to set gypsum compositions prepared using CSA (6A).

### EXAMPLE 7

This example illustrates a process for preparing a wet gypsum accelerator according to the inventive process using different grinding media.

A Premier SM-15 Supermill was used for the wet grinding of gypsum (landplaster) with additives. The SM-15 Supermill was filled with 81 volume % of 8 different grinding beads: 1.2-1.7 mm ZIRCONOX™ (7A), 0.7-1.2 mm ZIRCONOX™ (7B), 1.2 mm QBZ-95 (7C), 2.0 mm QBZ-58A (7D), 1.3 mm Quacksand (7E), 1.5 mm Q-Bead (7F), 1.6 mm QBZ-58A (7G), and 1.2 mm QBZ-58A (7H). The effects of each grinding media on viscosity and efficiency were evaluated in two runs.

For each sample, 3000 g of gypsum was added to 4000 mL of tap water. Next, 22.5 g of DEQUEST™ 2006 and 22.5 g of STMP was added to the slurry. The mill speed for all samples was set at 17,500 fpm. Slurry samples were taken at 5 minute intervals for viscosity measurements using a Brookfield RVT viscometer with a #4 spindle (40 rpm). Milling was halted after the slurry viscosity reached approximately 14,000 cps. Reported viscosity values are an average of the two experimental runs conducted for each grinding media. At the end of each run a final sample of the slurry was retained.

Time to 50% Hydration and Time to 98% Hydration values for each of the grinding media 7A-7H was measured as described in Example 3 and compared to CSA. CSA was prepared by adding 2.0 g to 800 g of CKS stucco and 1000 mL of tap water. WGA samples were prepared by adding 4.67 g of the slurry to 800 g of CKS stucco and 1000 mL of tap water. The WGA samples were at 43% solids. All of the samples had a 10 s soak time and mix time. Mixing was conducted using a small WARING™ blender at the high setting.

The viscosity for each sample 7A-7H as a function of grinding time is reported as an average of the two experimental runs in Table 12.

TABLE 12

| | Average Viscosity (cps) | | | | | | | |
|---|---|---|---|---|---|---|---|---|
| Grinding Time (min) | 7A | 7B | 7C | 7D | 7E | 7F | 7G | 7H |
| 5 | 1150 | 1100 | 900 | 700 | 450 | 700 | 650 | 750 |
| 10 | 3900 | 3400 | 2700 | 1750 | 1250 | 1850 | 1650 | 1850 |
| 15 | 9550 | 9350 | 6050 | 35550 | 2550 | 3450 | 3300 | 5050 |
| 20 | 15100 | 16800 | 11250 | 6050 | 5000 | 5400 | 5550 | 6600 |
| 25 | — | — | 17950 | 9050 | 8300 | 8050 | 8550 | 10650 |
| 30 | — | — | — | 12050 | 11950 | 11100 | 11700 | 14800 |
| 35 | — | — | — | 15300 | 17400 | 14100 | 15200 | — |
| 40 | — | — | — | — | — | 16100* | — | — |

*indicates viscosity value of a single experimental run

Time to 50% Hydration and Time to 98% Hydration data (reported as an average of two experimental runs) for each of samples 7A-7H are provided in Table 13.

TABLE 13

| | 7A | 7B | 7C | 7D | 7E | 7F | 7G | 7H |
|---|---|---|---|---|---|---|---|---|
| Time to 50% | 5:15 | 5:18 | 5:33 | 5:40 | 5:15 | 5:28 | 5:30 | 5:35 |
| Hydration | | | | | | | | |
| (min) | | | | | | | | |
| Time to 98% | 8:05 | 8:10 | 8:30 | 8:33 | 8:08 | 8:15 | 8:23 | 8:30 |
| Hydration | | | | | | | | |
| (min) | | | | | | | | |

The results given in Tables 12 and 13 demonstrate that all of the grinding media 7A-7H are suitable for use in accordance with the invention. The hydration results suggest that grinding media 7A and 7E are particularly well-suited. In addition, grinding media 7B provided the best and most consistent results for the milling process. Such consistency allows for the maintenance of a high WGA production rate with little to no deviation in the viscosity of the slurry.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A process for preparing a wet gypsum accelerator comprising:
(i) combining dry gypsum having a median particle size of about 15 μm or less and water to form a wet gypsum mixture, and
(ii) grinding the wet gypsum mixture for a period of time sufficient to reduce the median particle size of the gypsum in the wet gypsum mixture to form the wet gypsum accelerator.

2. The process of claim 1, further comprising combining at least one additive selected from the group consisting of an organic phosphonic compound, a phosphate-containing compound, and mixtures thereof with the wet gypsum mixture prior to or during grinding the wet gypsum mixture.

3. The process of claim 1, further comprising combining at least one additive selected from the group consisting of an organic phosphonic compound, a phosphate-containing compound, and mixtures thereof with the dry gypsum prior to forming the wet gypsum mixture.

4. (canceled)

5. The process of claim 2, wherein the dry gypsum has a median particle size of about 5 μm or less.

6. The process of claim 2, wherein the median particle size of the gypsum in the wet gypsum mixture is about 1.5 μm after grinding.

7.-14. (canceled)

15. A wet gypsum accelerator prepared by a process according to claim 1.

16. The wet gypsum accelerator of claim 15, further comprising at least one additive selected from the group consisting of an organic phosphonic compound, a phosphate-containing compound, and mixtures thereof.

17.-18. (canceled)

19. A process for preparing a wet gypsum accelerator comprising:
combining dry gypsum having a median particle size of less than about 20 μm and water to form a wet gypsum mixture,
(ii) grinding the wet gypsum mixture for a period of time sufficient to reduce the median particle size of the gypsum in the wet gypsum mixture to form the wet gypsum accelerator,
wherein the thy gypsum having a median particle size of less than about 20 μm is obtained by dry grinding.

20. The process of claim 19, further comprising combining at least one additive selected from the group consisting of an organic phosphonic compound, a phosphate-containing compound, and mixtures thereof with the wet gypsum mixture prior to or during grinding the wet gypsum mixture.

21. The process of claim 19, further comprising combining at least one additive selected from the group consisting of an organic phosphonic compound, a phosphate-containing compound, and mixtures thereof with the dry gypsum prior to forming the wet gypsum mixture.

22. The process of claim 20, wherein the dry gypsum has a median particle size of about 15 μm or less.

23. The process of claim 22, wherein the dry gypsum has a median particle size of about 5 μm or less.

24. The process of claim 20, wherein the median particle size of the gypsum in the wet gypsum mixture is about 1.5 μm after grinding.
